(19) United States
(12) Patent Application Publication
(10) Pub. No.: US 2009/0079368 A1
(43) Pub. Date: Mar. 26, 2009

(54) Electronic Direct Current Intermediate Circuit

(76) Inventors: Gunter Poppen, Radevormwald (DE); Uwe Caldewey, Dortmund (DE); Torsten Lang, Solingen (DE)

Correspondence Address: COLLARD & ROE, P.C., 1077 NORTHERN BOULEVARD, ROSLYN, NY, 11576, US

(21) Appl. No.: 11/992,982

(22) PCT Filed: Sep. 22, 2006
(86) PCT No.: PCT/EP2006/066621

§ 371 Date: Apr. 2, 2008

(30) Foreign Application Priority Data
Oct. 5, 2005 (DE) 10 2005 047 654.6
Oct. 20, 2005 (DE) 10 2005 050 278.4

(51) Int. Cl. H02P 25/08

(52) U.S. Cl. 318/254.1

(57) ABSTRACT

The invention relates to an electronic intermediate DC circuit which is to be used in brushless electric motors (1) such as reluctance motors and comprises a rectifier bridge (5) composed of diodes (4) and a capacitor that is connected downstream from the rectifier bridge (5). In order to improve the design of a circuit of this type in a structurally simple manner, two capacitors (6, 7) which have different capacities are connected downstream from the rectifier bridge (5).

The invention relates to an electronic direct current intermediate circuit for use with brushless electric motors, such as for example reluctance motors, comprising a rectifier bridge consisting of diodes and a capacitor connected downstream of the rectifier bridge.

In the case of brushless motors, such as for example reluctance motors, as are further used for example in domestic appliances such as domestic vacuum cleaners, the supply is effected from a direct current intermediate circuit. A passive direct current bridge is used as the initial stage for the mains sinewave voltage, which charges an electrolytic capacitor bank to the peak value of the input voltage. This intermediate circuit can be regarded as a store, from which the motor draws its energy via the rectifier and into which it can return its freewheel energy. The harmonics in the supply network resulting from the reverse charging of the intermediate circuit are damped, in so far as features are present for the respective application, by additional PFC features (for example, power factor correction chokes). If the intermediate circuit is charged up to the peak value of the mains voltage, no current is drawn from the mains. By supplying the motor from the capacitor of the intermediate circuit, this is discharged, as a result of which the intermediate circuit voltage falls below the peak value of the mains voltage. If the instantaneous value of the mains sinewave voltage being supplied now rises again above this voltage level, the capacitor begins to recharge, which results in a jump in the non-sinusoidal current growth in the supplying network. Maximum permissible values for the amplitudes of the mains harmonics resulting from this are specified by the Standard EN 61000-3. In order to comply with this, it is known to use the above-mentioned PFC features.

In the light of the above-described state of the art, a technical problem for the invention is seen is configuring an electronic direct current intermediate circuit of the kind in question in a constructionally simpler manner.

This problem is solved first and foremost by the subject matter of Claim 1, it being provided that two capacitors are connected downstream of the rectifier bridge, the capacitors having different capacitances. The solution according to the invention is accordingly based on the capacitor of the intermediate circuit being divided into two separate capacitors. These are connected in such a way that from the mains side, preferably a film capacitor is active, the capacitor having a low capacitance which is non-critical from the point of view of the Standard for harmonics. The freewheel energy is directed into a second, appropriately larger electrolytic capacitor. The two capacitors are connected in a parallel circuit between the mains side rectifier bridge and the drive side of the motor, thus for example connected upstream of an inverter or a transistor circuit.

The features of the further claims are described below with reference to the subject matter of Claim 1, but may also be of significance in their independent formulation.

It is thus provided that one capacitor, preferably therefore an electrolytic capacitor, has a relatively high capacitance of a multiplicity of microfarads, thus for example more than 50 μF or more than 250 μF, more than 500 μF or more than 1000 μF. The capacitance is matched to the possible freewheel energy of the motor. The additional capacitor, thus preferably a film capacitor, has a low capacitance of a few microfarads, thus for example less than 500 μF or less than 250 μF or less than 50 μF. Further preferred is for a blocking diode to be provided in parallel with the capacitors. In a preferred embodiment, this is connected in parallel with a zener diode. The arrangement of blocking diode and zener diode serves, during operation of the circuit on so-called weak supply networks, to reduce excess voltages occurring in the input capacitor (film capacitor of low capacitance) by transferring energy into the free-wheel capacitor (electrolytic capacitor of higher capacitance). According to the configuration of the invention, an electronic direct current intermediate circuit is constructed, which can accept the free-wheel energy from the motor without this leading to generation in the supplying network of harmonics outside the Standard, this with a reduction in weight and space requirement compared with the solutions from the known state of the art.

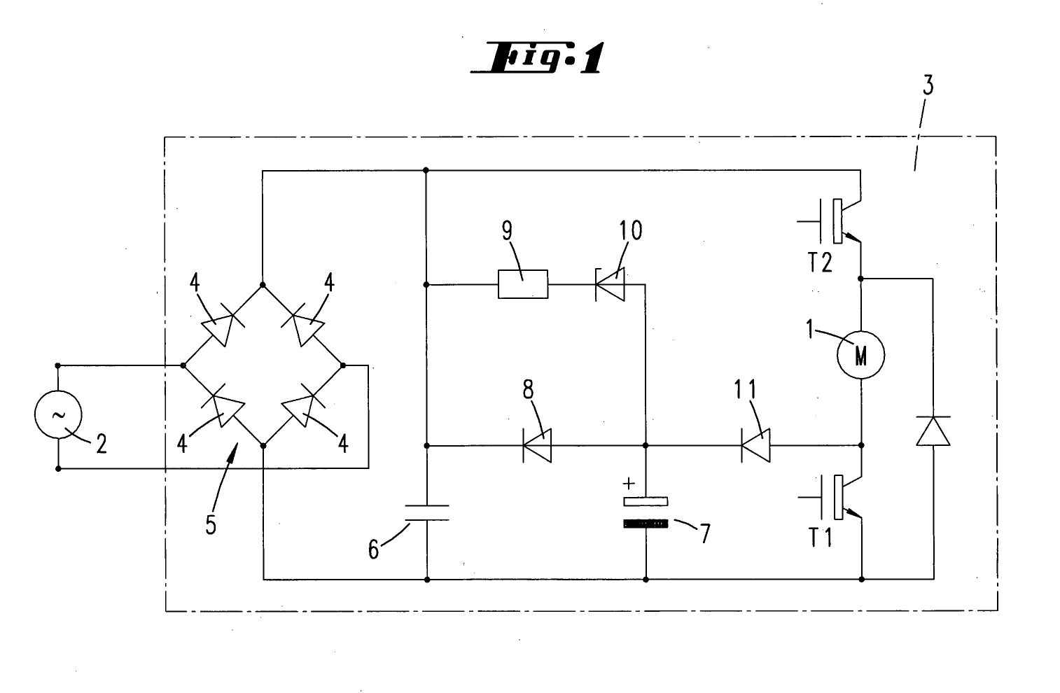

The invention is described in more detail below with reference to the accompanying drawing, which illustrates only one embodiment. FIG. 1 shows an exemplary circuit arrangement.

This circuit arrangement is used to supply a motor 1, which is here multiphase, from an energy supply network 2 with the interposition of a direct current intermediate circuit 3.

A rectifier bridge 5 consisting of diodes 4 is used as the initial stage for the mains sinewave voltage. Two capacitors 6 and 7 connected in parallel are supplied by this two-path bridge rectifier. The capacitor 6 is a film capacitor with a low capacitance of several microfarads. An electrolytic capacitor is provided as the second capacitor 7. As compared with the capacitor 6, this has a significantly higher capacitance. This is a multiplicity of microfarads, thus for example 500 μF.

The two capacitors 6 and 7 are connected to one another via a blocking diode 8 in such a way that from the supply side only the film capacitor 6 which forms an input capacitor is active, the capacitor 6 having a small capacitance which is non-critical from the point of view of the harmonics Standard. The freewheel energy is directed into the second, appropriately larger electrolytic capacitor 7.

In addition, the capacitors 6 and 7 are connected by a component group formed from a resistor 9 and zener diode 10 connected to each other in series. This component group made up of resistor 9 and zener diode 10, which is connected in parallel with the blocking diode 8, serves to reduce the excess voltages occurring in the input capacitor by transfer of energy into the free-wheel capacitor (electrolytic capacitor 7), when the circuit is operated on so-called weak supply networks.

The motor 3 is controlled via a transistor circuit (comprising transistors T₁ and T₂) connected downstream of the capacitor bank, with interposition of a further blocking diode 11.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

1-5. (canceled)

6. Electronic direct current intermediate circuit for use with brushless electric motors (1), such as for example reluctance motors, comprising a rectifier bridge (5) consisting of diodes (4) and a capacitor connected downstream of the rectifier bridge (5), two capacitors (6, 7) being connected downstream of the rectifier bridge (5) and the capacitors (6, 7) having different capacitances, wherein one capacitor (7) has a high capacitance of more than 50 microfarads and that one capacitor (6) has a low capacitance of less than 500 microfarads.

7. Direct current intermediate circuit according to claim 6, wherein a blocking diode (8) is provided in parallel with the capacitors (6, 7).

8. Direct current intermediate circuit according to claim 7, wherein the blocking diode (8) is connected in parallel with a zener diode (10).
